(19) United States
(12) Patent Application Publication
(10) Pub. No.: US 2026/0235218 A1
(43) Pub. Date: Aug. 13, 2026

(54) INSTRUMENT MOUNTING SYSTEM FOR FLUID CONTROL DEVICE

(71) Applicant: Fisher Controls International LLC, Marshalltown, IA (US)

(72) Inventor: Michel K. Lovell, Marshalltown, IA (US)

(21) Appl. No.: 19/050,837

(22) Filed: Feb. 11, 2025

(51) Int. Cl. F16K 17/10; F16K 31/122

(52) U.S. Cl. CPC F16K 17/10; F16K 31/122

(57) ABSTRACT

A fluid control device can include an actuator with a cylinder defining an interior volume, a piston arranged within the interior volume of the cylinder, the piston being translatable within the interior volume of the cylinder to control operation of the fluid control device, and an integrated instrument mounting system. The integrated instrument mounting system can include a lid removably mounted to an end of the cylinder to seal the interior volume of the cylinder, the lid defining a first port forming a flow path for instrument gas to pass into the interior volume of the cylinder, and an instrument mounted to the lid via the first port, the instrument and the lid together forming a unitary assembly.

### CROSS-REFERENCE TO RELATED APPLICATIONS

Not applicable.

### BACKGROUND

Fluid control devices, such as control valves, can be used in a variety of industrial, commercial, and other settings to regulate, protect, isolate, or maintain pipes, conduits, or other vessels and the flow of fluid therein (e.g., within a pipeline). However, typical fluid control device systems may be costly to manufacture or maintain. Further, typical fluid control device systems may often include instrumentation systems, which be complex to install, particularly in retrofit applications.

### SUMMARY

Some aspects of the present disclosure provide a fluid control device that can include a valve actuator with a cylinder defining an interior volume, a piston arranged within the interior volume of the cylinder, the piston being translatable within the interior volume of the cylinder to control operation of the fluid control device, and an integrated instrument mounting system. The integrated instrument mounting system can include a lid removably mounted to an end of the cylinder to seal the interior volume of the cylinder, the lid defining a first port forming a flow path for instrument gas to pass into the interior volume of the cylinder, and an instrument mounted to the lid via the first port, the instrument and the lid together forming a unitary assembly.

Some aspects of the present disclosure provide a method of installing an instrument on a valve. The method can include providing a valve actuator that includes a cylinder defining an interior volume, and a piston arranged within the interior volume of the cylinder, the piston being translatable within the interior volume of the cylinder to control operation of the valve, and removably mounting a unitary assembly to an end of the cylinder to seal the interior volume of the cylinder. The unitary assembly can include a lid that seals the interior volume and defines an instrument port forming a flow path for instrument gas to pass into the interior volume of the cylinder, and an instrument mounted to the lid via the instrument port.

Some aspects of the present disclosure provide a method of retrofitting an actuator of a fluid control device. The method can include removing a first lid from an end of a cylinder of the actuator, the cylinder housing a piston within a sealed interior volume defined by the cylinder and the first lid, the piston to translate within the interior volume to control operation of the fluid control device, and removably mounting a second lid to the end of the cylinder, the second lid including an instrument mounted directly to the lid to form a unitary assembly, the instrument mounted to the lid via an instrument port defining a flow path for instrument gas to pass into the interior volume of the cylinder to control operation of the fluid control device.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a perspective view of an example of a fluid control device according to aspects of the present disclosure.

FIG. 2 is a section view of an example of an actuator of the fluid control device of FIG. 1.

FIG. 3 is a cross-sectional view of one example of a cylinder of the actuator of FIG. 2.

FIG. 4 is a cross-sectional view of another example of a cylinder of the actuator of FIG. 2, with a piston of the actuator in a first position.

FIG. 5 is a cross-sectional view of the cylinder of FIG. 4, with the piston in a second position.

FIG. 6 is an axonometric view of an example of an instrument mounting system for use with a cylinder of the actuator of FIG. 2.

FIG. 7 is a cross-sectional view of the instrument mounting system of FIG. 6 installed on a cylinder of the actuator of FIG. 2.

FIG. 8 is an axonometric view of another example of an instrument mounting system for use with a cylinder of the actuator of FIG. 2.

FIG. 9 is a cross-sectional view of the instrument mounting system of FIG. 8 secured to the cylinder of FIGS. 4-5.

FIG. 10 is a cross-sectional view of yet another example of an instrument mounting system secured to the cylinder of FIGS. 4-5.

### DETAILED DESCRIPTION

The following discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown, but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As briefly discussed above fluid control systems can be used in a variety of industrial, commercial, and other settings to control fluid flow through pipes, conduits, or other vessels. Thus, a control valve as discussed herein can include an actuator including a cylinder (e.g., a pneumatic cylinder operating at 150 PSI or less). The cylinder can include a piston configured to move, in response to a force applied via a driving flow of pressurized fluid, to operate the valve actuator (e.g., move a valve stem to open/close valve). For example, a driving flow can be a flow of instrument gas (i.e., gas received from a known pneumatic flow control instrument), which may in turn be sourced from pressurized pipeline gas, a compressed air source, or otherwise, and controllably directed to move the piston in either of an opening or a closing direction.

The cylinder assembly may be a dual-wall cylinder with a first, inner cylinder and a second, outer cylinder. In some examples, the inner cylinder may be made from a first material with a first yield strength (e.g., various polymeric materials) and the outer cylinder may be made from a second, different material with a different yield strength (e.g., steel or another metallic material). For example, the inner cylinder may be made from a commercially available material designed for use in low pressure operations, while the outer cylinder may be made from a commercially available material designed for use in high pressure operations. Thus, the material strength of the outer cylinder may be greater than the material strength of the inner cylinder, with corresponding differences in rated pressure for cylinders of similar wall thickness and diameter.

Further, the outer cylinder may be arranged to surround the inner cylinder and contain fluid at a reference pressure (or pressures). As a result, the outer cylinder may set the maximum working pressure of the cylinder, while a rated pressure of the inner cylinder (in isolation) may correspond to the maximum differential pressure of the actuator (e.g., a relatively low value, set by various known actuator controllers). Accordingly, due to the dual-cylinder arrangement, the relatively weaker (e.g., low pressure) inner cylinder material may be used even in relatively high-pressure pipeline applications (e.g., when relatively high-pressure pipeline gas is provided as instrument gas to operate the actuator), which may provide an economical option for the cylinder arrangement. Further, the use of the dual-cylinder arrangement may work to contain the inner cylinder, so that in the event of a catastrophic failure of the inner cylinder, the inner cylinder (e.g., shrapnel) is contained within the outer cylinder.

In another example, the fluid control device may include an instrument mounting system. For example, the cylinder may include a removable lid, which may be removable and replaceable via the use of one or more fasteners. In some examples, the lid may serve as a mounting location for one or more relief valves (e.g., to maintain the predetermined differential pressure). In some examples, the lid may serve as a mounting location for one or more instruments of the valve (e.g., instruments as known in the art to amplify or direct a driving flow to cause particular movement of a piston or other actuator component). Thus, the instruments may be mounted directly to the lid instead of mounted elsewhere and plumbed to the relevant part of the actuator via complex plumbing arrangements. In such an arrangement, for example, the instruments and lid may form a unitary assembly that can be collectively installed onto a cylinder, with the lid securing attached instruments to the cylinder, supporting the attached instruments relative to the cylinder, or providing flow paths for flow of driving fluid between the instruments and the cylinder. This configuration may facilitate the ease of replacement or repair of the instruments or lid, without requiring installers to deal with complex plumbing issues.

Further, in some examples, a lid or other instrument mounting system may form a pressurized chamber configured to permit venting of instrument gas back into the pipeline (or other elevated-pressure fluid sink), without loss of the instrument gas to the atmosphere (e.g., without venting pipeline gas that is used, via the instrument(s) to operate the actuator). In one example, the pressurized chamber has a dynamic pressure, and is fluidly connected to (i.e., in fluidic communication with) a downstream portion of the pipeline. Thus, as the pressure in the downstream pipeline changes, the pressure within the chamber may correspondingly change, and fluid vented (e.g., via one or more instruments) into the chamber can naturally flow from the chamber back into the pipeline.

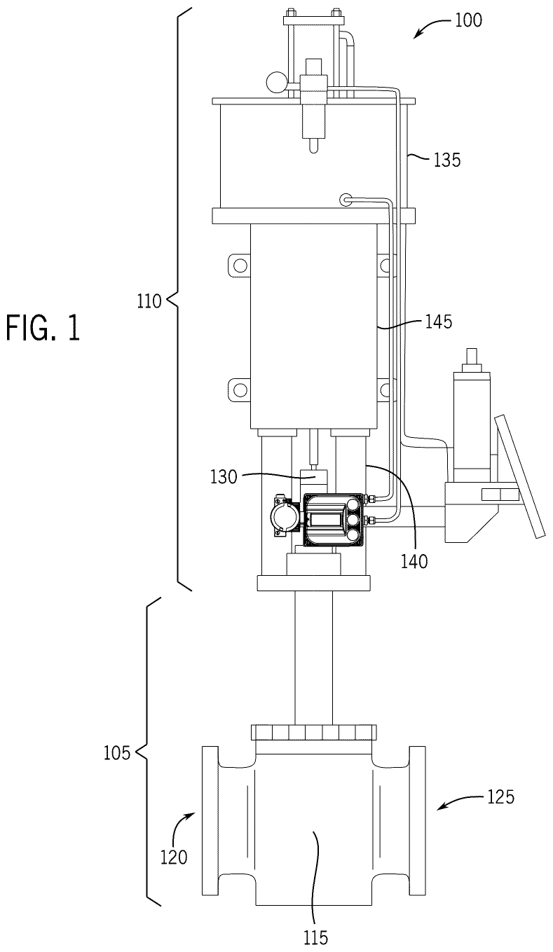

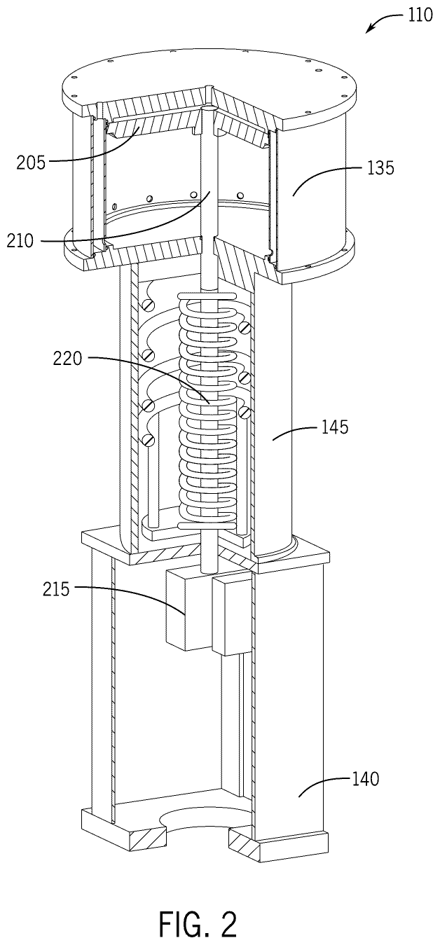

FIGS. 1 and 2 illustrate an example of a fluid control device (e.g., a control valve, louver, etc.) for use with a natural gas or other pipeline. In one particular example, the fluid control device may be in the form of a valve 100, which may control fluid flow rate, pressure drop, or other factors between an upstream portion or inlet 120 (with respect to valve 100) and a downstream portion or outlet 125 (with respect to valve 100) of the pipeline. The valve 100 may be any of a variety of known types, such as a ball valve, gate valve, butterfly valve, diaphragm valve, globe valve, plug valve, check valve, or any other form of valve used to modify pipeline pressure or flow. In one particular example, the valve may be a push down to close valve with fail open actuation.

In some examples, the valve 100 may be in fluidic communication with a process fluid (e.g., natural gas, oil, water, or other fluids) flowing through the pipeline. The valve 100 may be stroked (i.e., moved/actuated) by an actuator 110 (e.g., attached actuator portion) to close, open, or otherwise adjust a position of a valve stem 130 of the valve 100 within a valve body 115 to generate a predetermined pressure or flow rate of fluid in the downstream portion of the pipeline. In some examples, the actuator 110 may include a cylinder 135, with a piston 205 and corresponding piston rod 210 (or other pressure-movable assembly) configured to actuate the valve stem 130. For example, the piston rod 210 may be connected to the valve stem 130 via a valve stem connector 215 arranged within a yoke 140 of the actuator 110.

In some examples, the actuator 110 may be a double acting piston type actuator. In other examples, the actuator 110 may be a single acting piston type actuator, or may have other known configurations. In some examples, the actuator may include a biasing element 220 (e.g., spring) within a housing 145 and configured to cause the actuator to “fail-open”. In other examples, the biasing element may be positioned or configured to cause the actuator to “fail-closed.” As should be appreciated, the biasing element 220 may operate the actuator in certain situations, such as situations with insufficient differential pressure (dP) to operate the actuator 110.

In one example, the valve 100 may be actuated through the use of instrument gas, which may be diverted from the pipeline to operate the actuator 110. In other examples, the valve 100 may be actuated via the use of instrument gas from one or more air compressors (e.g., separate from the pipeline). In some particular examples, when using instrument gas from the pipeline, the instrument gas may be re-injected into a downstream portion of the pipeline after use. Thus, the control valve 100 can function in a zero-emission state, meaning that the valve functions without the loss of driving fluid (e.g., pipeline gas) to the atmosphere. As should be appreciated, this configuration can help to prevent loss of valuable material (e.g., via loss of gas) and avoidance of release events that may incur reporting requirements or other regulatory consequences (e.g., relating to venting of natural gas to atmosphere).

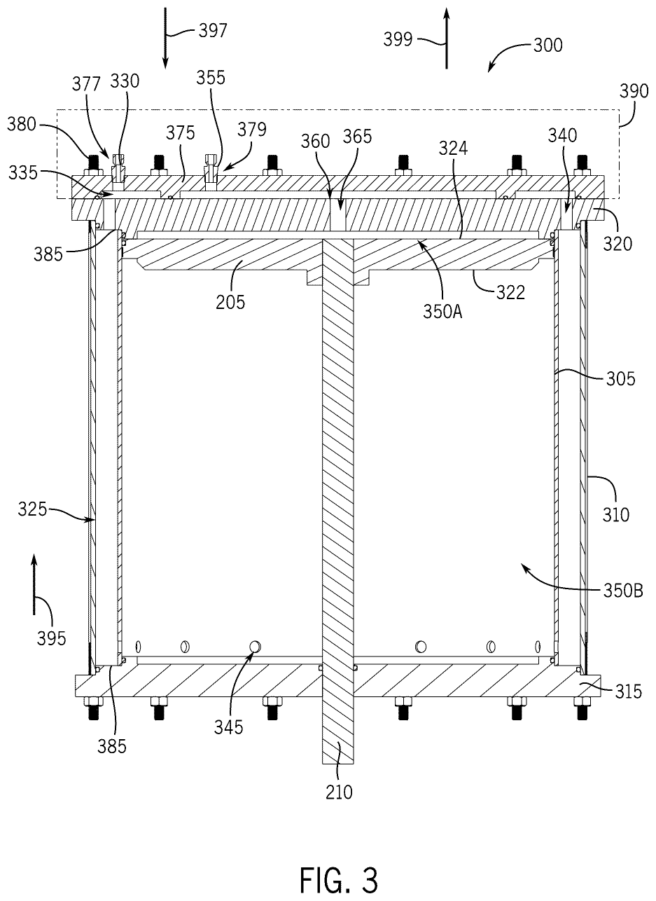

FIG. 3 shows one example of an actuator that includes a cylinder assembly 300 for use with the valve 100 discussed previously. As shown, the cylinder assembly 300 may include a dual-wall arrangement, with a first, inner cylinder 305 surrounded by a second, outer cylinder 310. In particular, the outer cylinder 310 exhibits an internal diameter that is larger than an external diameter of the inner cylinder 305, so that a radial gap (i.e., a gap in the radial direction) extends circumferentially between the two cylinders 305, 310. In some examples, this dual-wall configuration may permit the use of a relatively weaker material, with otherwise beneficial operational properties (e.g., sealing characteristics, frictional characteristics, etc.), for actuators that are operated by relatively high pressure inputs (e.g., operated by diverted pipeline gas, in unpowered or remote locations).

In particular, due to the dual-wall arrangement, the maximum rated working pressure of the cylinder assembly 300 may be set at a relatively high value by the outer cylinder 310, while the inner cylinder 305 may be operated by relatively high input pressure, but subjected to only a relatively small net-pressure loads (e.g., differential pressures). For example, for a pipeline actuator, with the radial gap pressurized to a downstream pipeline pressure (e.g., 1500 PSI), the inner cylinder 305 may be sized (e.g., in radial thickness) for a working pressure that is slightly higher than the downstream pipeline pressure, which may provide a differential pressure (dP). In some examples, the inner cylinder 305 may be sized for a differential pressure of up to about 150 PSI. Thus, for example, improved operational characteristics for the inner cylinder 305 can be obtained through the use of composite materials (e.g., for reduced-friction or reduced-corrosion operation), without requiring prohibitive material thicknesses to contain the relatively high input pressure received from a pipeline (or other input source).

In some examples, the inner cylinder 305 can be formed from fiber-reinforced composite materials (e.g., integrally molded into tubing) or other composite (i.e., polymeric, non-metallic) materials. In some examples, composite materials can include underlying substrates (e.g., fiber-reinforced polyepoxides), in combination with various surface treatments to provide bearing surfaces for actuator pistons. For example, inner walls of actuator cylinders can be formed on a mandrel, coated with gels, or otherwise subjected to known surface treatments (e.g., honing, etc.), to provide reduced friction or improved corrosion as compared to the underlying composite substrate (e.g., an underlying fiber-reinforced composite tube). In some examples, an inner (or other) cylinder can be formed from fiber-reinforced thermoset epoxy resin (e.g., currently offered by Amalga Composites under the trade name (or mark) Black Amalgon) or another reinforced composite, while an outer (or other) cylinder can be formed from a relatively stronger material (e.g., steel or another metallic material. For example, the outer cylinder can be made from a material that matches a material of the downstream pipeline (e.g., ASTM A106 Grade B steel). This configuration may be advantageous as the inner cylinder material may be low friction, light weight, long lasting, and corrosion resistant. However, the relatively stronger outer cylinder may provide additional structural strength and fire resistance to the cylinder assembly 300. Further, the outer cylinder may not have to undergo any honing or other surface treatment, which may reduce overall costs and increase manufacturing efficiency. In other examples, it should be appreciated that the inner cylinder and the outer cylinder may be made from the same material (e.g., a composite material, metallic material, etc.). For example, the inner cylinder and the outer cylinder may both be made from the same material, but with the inner cylinder having a relatively thinner wall thickness vs. the outer cylinder. In other examples, the inner cylinder and the outer cylinder may be the same, with the wall thickness remaining consistent between the inner and outer cylinders.

In some examples, to form the dual-wall arrangement, the inner cylinder 305 and the outer cylinder 310 may be secured (e.g., clamped) between a pair of endcaps (e.g., a first endcap 315 and a second endcap 320). For example, the inner and outer cylinders may be clamped between respective inner surfaces 385 of the endcaps 315, 320 via the use of one or more tie rods 380. In some examples, to mitigate the risk of damage to the inner cylinder 305, the endcaps 315, 320 may only apply clamping force to the outer cylinder 310 or may apply clamping force to the outer cylinder that is significantly larger than clamping force simultaneously applied to the inner cylinder. In other words, the majority of the clamping stress may be borne by the stronger outer cylinder 310, rather the inner cylinder 305. For example, the clamping force applied to the inner cylinder may be below a longitudinal compressive strength of the inner cylinder material (e.g., 20 kPSI), which may be relatively smaller than a longitudinal compressive strength of the outer cylinder material. Further, in some examples, due to the dual-wall arrangement, only the inner cylinder 305 may seal against the piston 205, which may reduce the need for machining or honing the outer cylinder 310 and correspondingly decrease manufacturing costs for the cylinder assembly 300.

In some examples, the cylinder may include a lid 375 positioned on an opposite side of the second endcap 320 from the cylinders 305, 310. In some examples, the tie rods 380 may pass through the lid 375 in addition to the endcaps 315, 320 to secure the lid in position. For example, the endcap 320 may be clamped between the lid 375 and the cylinders 305, 310 so that the lid 375 seals the interior volume of the cylinders. In some cases, the lid 375 can alternatively form an endcap, or can be included in a unitary assembly that includes an endcap (e.g., as further discussed below).

In some examples, the lid 375 may serve as a mounting location for various instrument connections (e.g., to provide instrument gas or other driving fluid to the cylinder assembly 300). In one particular example, the lid may form an integrated instrument mounting system 390, which may include one or more integrated instrument ports to provide fluidic communication between an instrument and an internal volume of the cylinders 305, 310. For example, the integrated instrument mounting system 390 may include ports 377, 379, which provide a mounting location for air connections 330, 355. Correspondingly, the port 377 may provide a path for instrument gas to flow into an interior volume of the inner cylinder 305 on a first side of the piston 205, while the port 379 may provide a path for instrument gas to flow into the interior volume of the inner cylinder 305 on a second side of the piston 205, as also further detailed below.

Generally, the ports 377, 379 can be in fluidic communication with opposing sides of the piston 205, respectively, to allow selective movement of the piston 205 via controlled flow of driving fluid through the port(s) 377, 379. In some examples, in order to operate the valve (e.g., via movement of the piston 205 within the cylinder assembly 300) the inner cylinder 305 may include one or more perforations 345, which may circumferentially surround a first end of the inner cylinder 305. The perforations 345 may permit the flow of fluid (e.g., instrument gas) into an interior volume of the inner cylinder 305. In some examples, the interior volume of the inner cylinder 305 may be separated by the piston into a first interior volume 350B and a second interior volume 350A collectively defining an interior volume of the inner cylinder 305 (e.g., in double acting piston type actuators). For example, the perforations 345 may permit the flow of fluid into a first interior volume 350B on a first side 322 of the piston 205. For example, so that the instrument gas may apply a force in the direction shown by arrow 395 to the piston 205 (e.g., corresponding to opening the valve 100).

As also noted above, in some examples, due to a difference in diameter between the inner cylinder 305 and the outer cylinder 310, a gap 325 may be formed between the inner and outer cylinders. Thus, instrument gas may pass from the air connection 330, into a circumferential channel 335 (e.g., internally formed groove) of the lid 375. Following this, instrument gas may flow along the channel 335 and pass through one or more apertures 340 in the second endcap 320 (e.g., circumferentially arrayed), which may accordingly direct the instrument gas into the gap 325 between the inner and outer cylinders. From the gap 325, the instrument gas may then pass through the perforations 345 into the first interior volume 350B of the inner cylinder 305 on the first side 322 of the piston and apply a force to a first side of the piston 205. Correspondingly, the piston may move in the direction shown by arrow 399, while exhaust flow may pass through an opening 365 in the second endcap 320 (e.g., out of a second interior volume on the second side of the piston).

In some examples, in order to move the piston 205 in the opposite direction of that shown by arrow 395 (e.g., close the valve 100), the instrument gas may be provided by the air connection 355. For example, from the air connection 355, instrument gas can pass into a central channel 360 within the lid 375. From the channel 360, the instrument gas may then pass through a central (or other) opening 365 in the second endcap 320, which may direct instrument gas into the interior volume of the inner cylinder 305. For example, the instrument gas may pass though the opening 365 into a second interior volume 350A on a second side 324 of the piston 205 and thus apply a force to the second side of the piston 205. Correspondingly, the piston may move in the direction shown by arrow 397, while exhaust flow may pass through the gap (e.g., out of the first interior volume on the first side of the piston).

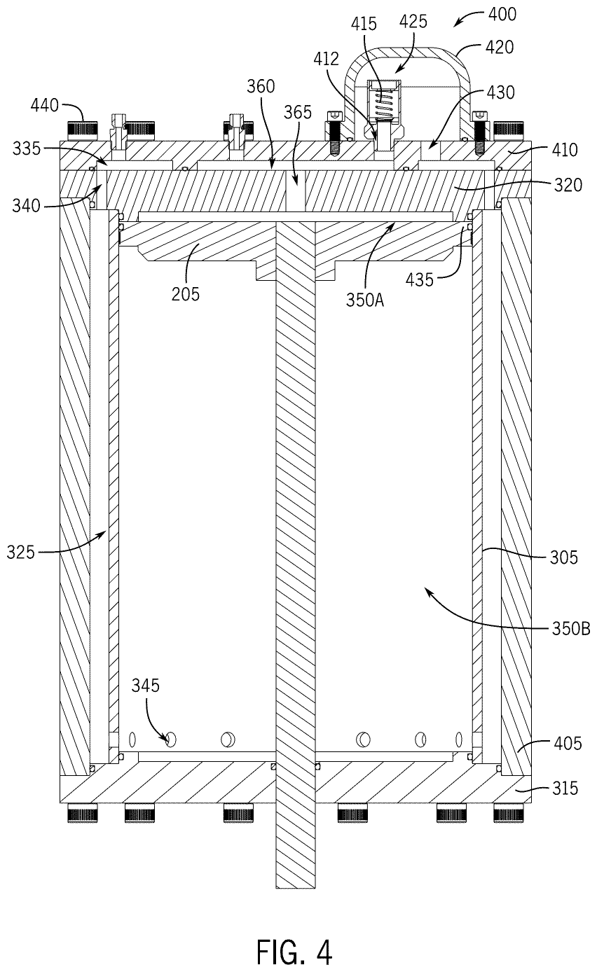

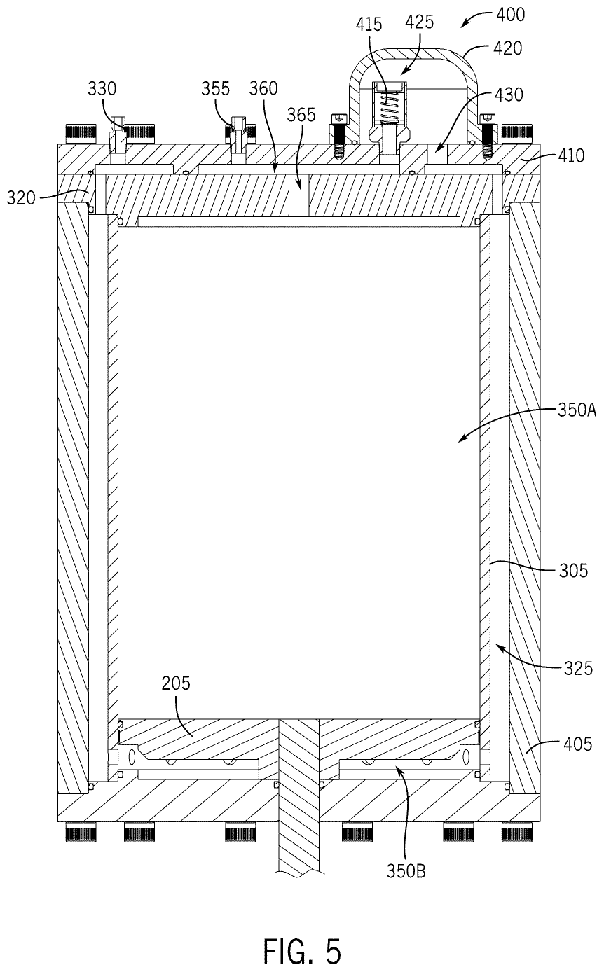

FIGS. 4 and 5 illustrate another example of a cylinder assembly 400 that can be used with the control valve 100 of FIG. 1 (e.g., as an alternative configuration of the cylinder assembly 300). As will be recognized, the cylinder assembly 400 shares a number of components in common with and operates in a similar fashion to the examples illustrated and described previously. For the sake of brevity, these common features will not be again described below in detail. Rather, previous discussion of commonly named or numbered features, unless otherwise indicated, also applies to example configurations of the cylinder assembly 400.

In some examples, as mentioned previously, due to the dual-wall arrangement of the cylinder, the differential pressure rating of the outer cylinder may be adjusted independently of the differential pressure rating of the inner cylinder. In some examples, the pressure rating of the cylinder can be adjusted to match the maximum pressure rating of the downstream pipeline, which may permit venting (e.g., reintroduction) of instrument gas from the cylinder to the downstream pipeline (e.g., to provide a zero-emission system). In one particular example, as shown in FIG. 4, the outer cylinder 405 may be made from relatively higher pressure rated material than the outer cylinder of FIG. 3. For example, the outer cylinder 405 may be made from Schedule 100 steel pipe, which may provide the cylinder assembly 400 with a rated pressure of about 1500 PSI. Further, due to the increased wall thickness of the outer cylinder 405, rather than using the tie rods 380, the endcaps 315, 320 and the lid (e.g., lid 410) may be secured via one or more bolts or other threaded fasteners 440.

In some examples, when the piston 205 is in a first position, with the piston 205 in contact with an end stop 435 of the second endcap 320 (e.g., as shown in FIG. 4) or other end stop, the pressure in the gap 325 and the in the first interior volume 350B on the first side 322 of the piston 205 within the inner cylinder 305 may be about equal, with the differential pressure across the walls of the inner cylinder correspondingly at or near zero. Thus, the inner cylinder 305 may be protected from damage, even if the current operating pressure of the cylinder assembly 400 is above the maximum pressure rating of the inner cylinder 305 in isolation (e.g., corresponding to full-pressure operation, with the outer cylinder 405 defining the rated pressure of the cylinder assembly 400). However, when the piston 205 is in a second position spaced apart from the end stop 435 (e.g., at an opposite end of travel, as shown in FIG. 5), the pressure in the gap 325 and in the second interior volume 350A on the second side 324 of the piston 205 within the inner cylinder 305 may be different (e.g., a differential pressure may exist between the two volumes, across the walls of the inner cylinder 305).

Thus, to protect the inner cylinder 305 from damage (e.g., due to a differential pressure above the rated differential pressure, a pressure relief valve 415 may be secured to a port 412 in fluidic communication with the central channel 360 (e.g., extending through the lid 410, as shown). In some examples, the pressure relief valve 415 may be positioned within a sealed enclosure 420 removably mounted to the lid 410. In some examples, the sealed enclosure 420 may be in fluidic communication with the gap 325 via an opening 430 extending through the lid 410, so the pressure of gas within an interior volume 425 of the enclosure 420 may be about equal to a pressure of gas in the gap 325. Thus, when a differential pressure between the interior volume (e.g., the second interior volume 350A) of the inner cylinder 305 and the gap 325 exceeds a predetermined value (e.g., about 150 PSI), the relief valve 415 may open and vent gas from the top side of the inner cylinder 305 into the interior volume 425. In this way, for example, the relief valve 415 may protect the inner cylinder 305 from damage.

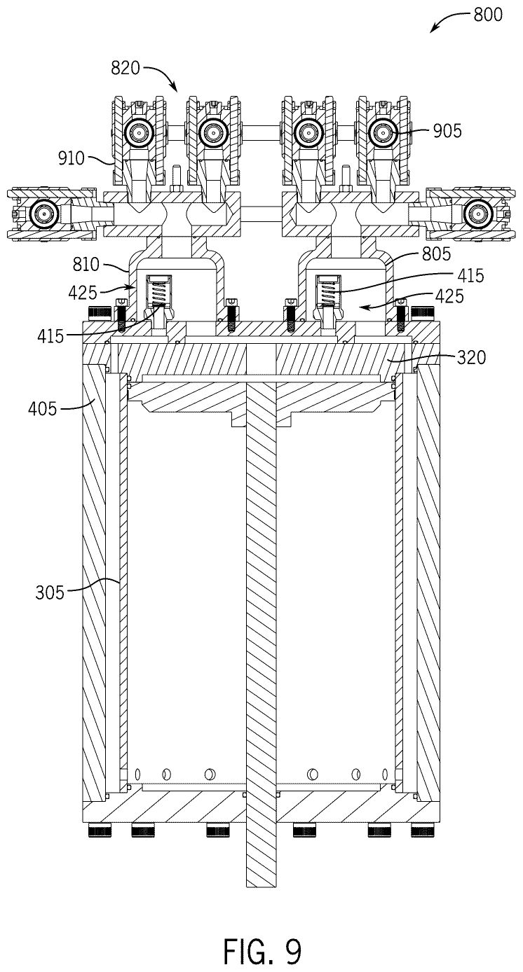

In some examples, it is possible that the piston 205 may become stuck between the first and second positions, which may prevent the piston from contacting the end stop 435. To mitigate the risk of damage to the inner cylinder 305 in this case, a second relief valve may be provided (see, e.g., FIG. 9). For example, the second relief valve may be in fluidic communication with the circumferential channel 335 so that when a differential pressure between the gap 325 and the interior volume (e.g., the second interior volume 350A) of the inner cylinder 305 exceeds a predetermined value (e.g., about 150 PSI), the second relief valve may open to vent pressure from the gap (and the lower side of the piston 205) to the interior volume on the upper side of the piston 205.

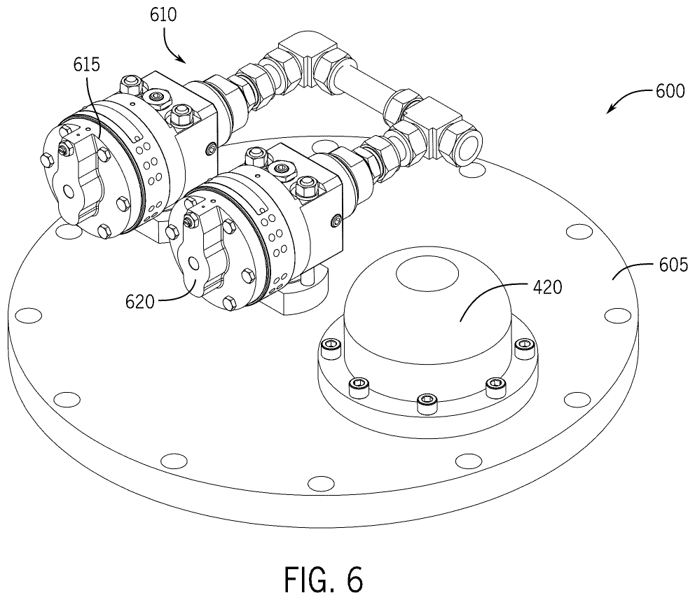

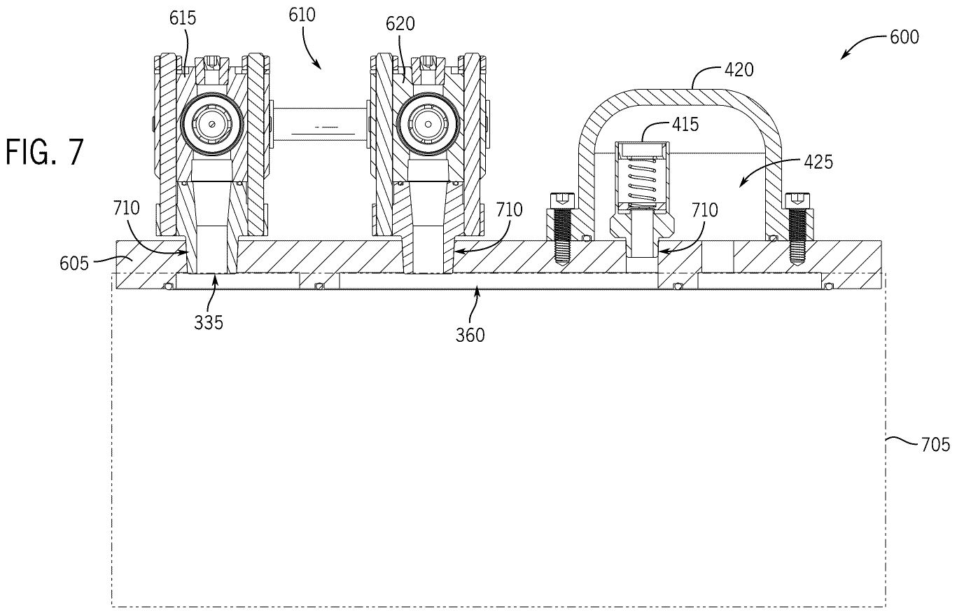

FIGS. 6 and 7 show an example of an instrument mounting system 600 for use with a cylinder 705 (or cylinders 300, 400). In some examples, the instrument mounting system 600 may be a unitary assembly (i.e., connected together to be installable and removable as a single piece, collectively supported relative to the corresponding cylinder). For example, the system 600 may be a unitary assembly that includes a lid 605 and one or more instruments 610 mounted to the lid to be collectively supported relative to the corresponding cylinder by the lid 605. In some examples, the lid 605 provides a relatively large, rigid, flat surface area for direct mounting of instruments 610 with direct access to both sides of the piston 205 without the need for external piping or tubing. For example, the instruments 610 may be mounted to the lid 605 using one or more instrument ports 710, which may provide a flow path for instrument gas to flow to/from the instruments from/to the interior volume of the cylinder 705. In some examples, the instruments 610 may be in the form of one or more volume boosters (e.g., a first volume booster 615 and a second volume booster 620), pneumatic controllers, or any other known instruments for control (e.g., one-way volume boosters, solenoids, trip valves, regulators, etc.).

In some examples, the instrument mounting system 600 may be removably mountable to the cylinder 705 via one or more fasteners (e.g., screws, bolts, tie rods, or any other known fasteners) so that the instrument mounting system 600 may be removable/replaceable by a user (e.g., as a unitary assembly). Thus, the instrument mounting system 600 may be removed and replaced for maintenance, to change instrument types, or for retrofit applications by simply removing the fasteners, removing the first lid from the cylinder, placing a second lid on the cylinder, and securing the lid by replacing the fasteners.

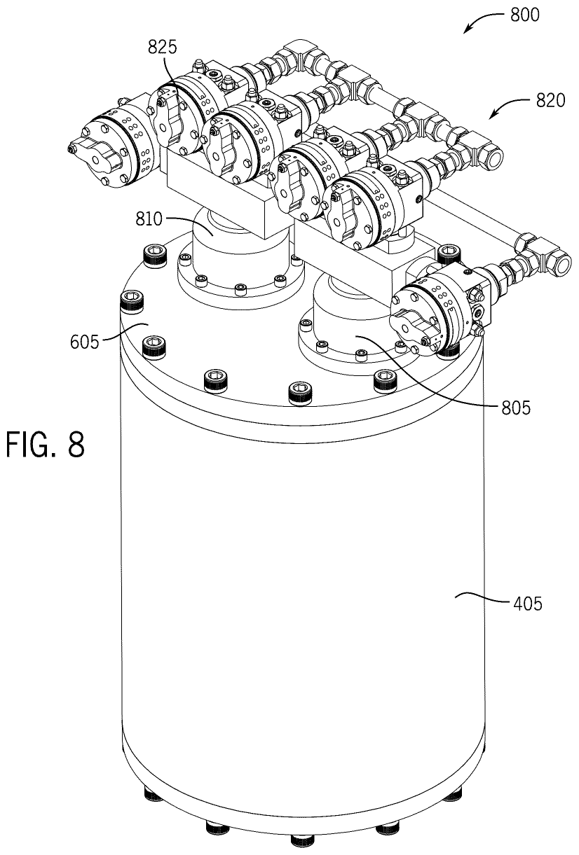

FIGS. 8 and 9 illustrate another example of an instrument mounting system 800 that can be used with the cylinder(s) of the control valve of FIG. 1 (e.g., as an alternative configuration of the instrument mounting system 600). As will be recognized, the instrument mounting system 800 shares a number of components in common with and operates in a similar fashion to the examples illustrated and described previously. For the sake of brevity, these common features will not be again described below in detail. Rather, previous discussion of commonly named or numbered features, unless otherwise indicated, also applies to example configurations of the instrument mounting system 800.

In some examples, the instrument mounting system 800 may be used with the cylinders 300, 400 described previously. For example, the instrument mounting system 800 may include a pair of sealed enclosures 805, 810 (e.g., for relief valves or other instruments) secured to the lid 605 of the instrument mounting system 800. Further, the instrument mounting system 800 may include a series of instruments 820, which may be secured to the sealed enclosures 805, 810. Thus, the instruments 820 may be secured to the lid 605 via the relief valve enclosures 805, 810. For applications that do not include relief valves, the instruments 820 could be mounted directly to the lid 605 (e.g., through one or more instrument ports 710).

In some examples, the instruments 820 may be in the form of one or more volume boosters 825. In one particular example, in applications requiring fast stroke speeds it may be beneficial to use multiple dead band volume boosters 825 to achieve the required stroke speed. Thus, two volume boosters may be plumbed in parallel to the upper cylinder (e.g., one side of the piston 205) and two volume boosters may be plumbed in parallel to the lower cylinder (e.g., the other, opposite side of the piston 205), which may facilitate fast motion in each direction. In another example, the instrument 820 may be in the form of a pneumatic controller, which may include a remote travel sensor (e.g., mounted adjacent the yoke 140) and a base unit, which may be mounted to the lid 605.

As should be appreciated, the instruments 820 may require maintenance or even replacement during their lifetime. In this regard, one useful feature of the instrument mounting system 800 is that all of the instruments 820 may be secured directly to the lid 605 to form a unitary assembly. Thus, by simply removing the lid 605 (e.g., via removal of the fasteners), all of the instruments 820 may be removed/disconnected as well, without having to deal with complex plumbing or other issues. This configuration accordingly eliminates the need to disturb any pipe fittings when retrofitting, replacing, or performing maintenance on the instruments and further eliminates the risk of accidentally re-installing the instruments incorrectly.

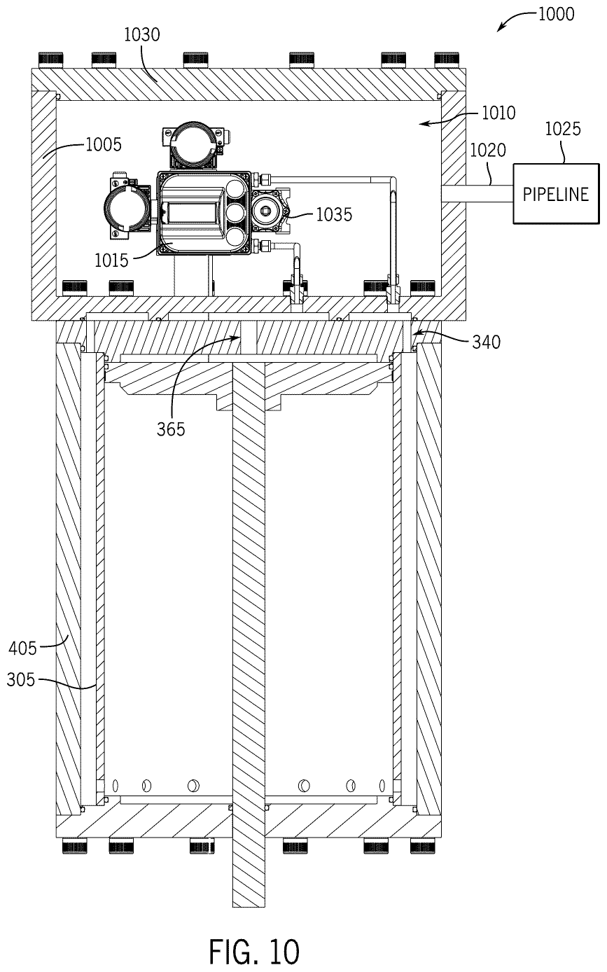

FIG. 10 illustrates another example of an instrument mounting system 1000 that can be used with the cylinder(s) of the control valve of FIG. 1 (e.g., as an alternative configuration of the instrument mounting system 800). As will be recognized, the instrument mounting system 1000 shares a number of components in common with and operates in a similar fashion to the examples illustrated and described previously. For the sake of brevity, these common features will not be again described below in detail. Rather, previous discussion of commonly named or numbered features, unless otherwise indicated, also applies to example configurations of the instrument mounting system 1000.

In some examples, when using instrument gas from the pipeline, the instrument mounting system 1000 may be configured to reinject the instrument gas into a downstream portion of the pipeline after use. Thus, the control valve 100 can function in a zero-emission state, meaning that the valve functions without the loss of gas (e.g., pipeline gas) to the atmosphere. As should be appreciated, this configuration can help to prevent loss of valuable material (e.g., via loss of gas) and avoidance of release events that may incur reporting requirements or other regulatory consequences (e.g., relating to venting of natural gas to atmosphere).

In the illustrated example, to accomplish this zero-emission state, one or more instruments 1015 (e.g., positioners, relief valves, relays, regulators, volume boosters, trip valves, etc.) that are used to control operation of the valve 100 are contained within a pressurized chamber 1010. For example, to form the pressurized chamber 1010, the instrument mounting system 1000 may include a body 1005 and a removable cap 1030. In some examples, the body 1005 may be removably secured to the cylinder (e.g., any of cylinders described previously) via one or more fasteners. Similarly, the cap 1030 may be removably secured to the body 1005 via one or more fasteners. Thus, a user may remove the cap 1030 to access the pressurized chamber 1010 (e.g., to replace, maintain, or remove one or more instruments 1015).

In some examples, because the chamber pressure is equal to (or greater than) the downstream pressure, any fluid consumed by the instruments 1015 (e.g., as initially drawn from an upstream location of the pipeline) can thus be re-injected into a lower-pressure (e.g., downstream) portion of the pipeline 1025 via a vent 1020. For example, a pressure regulator 1035 within the chamber 1010 may automatically adjust to the downstream pressure (e.g., in the downstream portion of the pipeline) and correspondingly adjust an upstream pressure (e.g., in the upstream portion of the pipeline) to maintain a desired differential pressure, which may permit re-injection of fluid used by the instruments into the downstream portion of the pipeline. This configuration can eliminate bleed to the atmosphere, while still allowing the use of various conventional instruments. For example, an instrument that is rated to operate based on a particular differential pressure relative to a standard environment (e.g., with a standard pressure equal to 1 atmosphere or 14.7 Pounds Per Square Inch Absolute (PSIA)), can be similarly operated at a higher absolute pressure, but with the same (rated) differential pressure, in the environment of elevated pressure provided by the pressurized chamber 1010.

Put differently, the traditional design and operation of pneumatic instrumentation used in process control industries is predicated on a static reference pressure equal to the local atmospheric pressure. These instruments can be integrated into a control system because each instrument has a common reference pressure (e.g., local atmospheric pressure). The common atmospheric reference pressure also ensures that the gas consumed by the instruments can be vented when required. In contrast, the chamber 1010 provides an alternate reference pressure for the pneumatic instruments that can be elevated and dynamic in nature. Thus, for example, as the reference pressure (e.g., downstream pipeline pressure, pressure in the cylinders 305, 405, etc.) fluctuates the pneumatic instrument pressures can “float” with the reference pressure fluctuation, so that sufficient pressure differential is maintained to operate the instruments and sufficient output pressure is maintained to reinject the instrument gas into the pipeline. This allows the instruments to provide accurate and responsive control while also venting into the downstream pipeline, substantially eliminating venting of the gas to the atmosphere.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system. In this regard, for example, examples of the disclosed technology can include improved actuators and actuator components, correspondingly improved valves and valve assemblies, and methods of manufacturing, installing (e.g., as a retrofit), and uninstalling such apparatuses.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “substantially parallel” indicates a direction that is within ±12 degrees of a reference direction (e.g., within ±6 degrees), inclusive.

Also as used herein, unless otherwise limited or defined, “substantially perpendicular” indicates a direction that is within ±12 degrees of perpendicular a reference direction (e.g., within ±6 degrees), inclusive.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, unless otherwise specified or limited, the terms “about” and “approximately,” as used herein with respect to a reference value, refer to variations from the reference value of ±15% or less, inclusive of the endpoints of the range. Similarly, the term “substantially equal” (and the like) as used herein with respect to a reference value refers to variations from the reference value of less than ±30%, inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order. Relatedly, similar or identical components may be referred to with different ordinal numbers in different contexts.

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A fluid control device, comprising:
an actuator, including:
a cylinder defining an interior volume;
a piston arranged within the interior volume of the cylinder, the piston being translatable within the interior volume of the cylinder to control operation of the fluid control device; and
an integrated instrument mounting system, including:
a lid removably mounted to an end of the cylinder to seal the interior volume of the cylinder, the lid defining a first port forming a flow path for instrument gas to pass into the interior volume of the cylinder; and
an instrument mounted to the lid via the first port, the instrument and the lid together forming a unitary assembly.

2. The fluid control device of claim 1, wherein the lid defines a second port forming a flow path for instrument gas to pass out of the interior volume of the cylinder, and wherein a relief valve is mounted to the lid via the second port.

3. The fluid control device of claim 2, wherein the relief valve is housed within an enclosure that forms a pressurized chamber surrounding the relief valve, and the relief valve vents into the enclosure from a first side of the piston within the interior volume of the cylinder.

4. The fluid control device of claim 3, wherein the enclosure is removably mounted to the lid.

5. The fluid control device of claim 3, wherein the pressurized chamber has a dynamically variable pressure corresponding to a pressure on a second side of the piston within the interior volume of cylinder.

6. The fluid control device of claim 1, wherein the instrument is a volume booster.

7. The fluid control device of claim 1, wherein the lid includes a body and a cap that together form a pressurized chamber, and wherein the instrument is arranged within the pressurized chamber so that instrument gas leaked from the instrument is captured within the pressurized chamber.

8. The fluid control device of claim 2, wherein the lid defines a third port forming a flow path for instrument gas to pass out of the interior volume of the cylinder, and wherein a second relief valve is mounted to the lid via the third port.

9. The fluid control device of claim 8, wherein the second relief valve is housed within an enclosure that forms a pressurized chamber surrounding the second relief valve, and the second relief valve vents into the enclosure from a second side of the piston within the interior volume of the cylinder.

10. A method of installing an instrument on a valve, the method comprising:
providing a valve actuator that includes: a cylinder defining an interior volume; and a piston arranged within the interior volume of the cylinder, the piston being translatable within the interior volume of the cylinder to control operation of the valve; and
removably mounting a unitary assembly to an end of the cylinder to seal the interior volume of the cylinder, the unitary assembly including: a lid that seals the interior volume and defines an instrument port forming a flow path for instrument gas to pass into the interior volume of the cylinder; and an instrument mounted to the lid via the instrument port.

11. The method of claim 10, wherein the instrument is a relief valve.

12. The method of claim 11, wherein the relief valve is housed within an enclosure removably mounted to the lid.

13. The method of claim 12, wherein the enclosure forms a pressurized chamber surrounding the relief valve.

14. The method of claim 13, wherein the pressurized chamber has a dynamically variable pressure corresponding to a pressure in the interior volume of cylinder.

15. The method of claim 10, wherein the lid includes a body and a cap together forming a pressurized chamber, and the instrument is arranged within the pressurized chamber.

16. The method of claim 15, further comprising:
connecting the pressurized chamber to a downstream portion of a pipeline to have a dynamically variable pressure corresponding to a pressure in the downstream portion of a pipeline.

17. The method of claim 16, wherein instrument gas leaked from the instrument is captured within the chamber and reinjected into the downstream portion of the pipeline via a vent connecting the pressurized chamber and the downstream portion of the pipeline.

18. A method of retrofitting an actuator of a fluid control device, the method comprising:
removing a first lid from an end of a cylinder of the actuator, the cylinder housing a piston within a sealed interior volume defined by the cylinder and the first lid, the piston to translate within the interior volume to control operation of the fluid control device; and
removably mounting a second lid to the end of the cylinder, the second lid including an instrument mounted directly to the lid to form a unitary assembly, the instrument mounted to the lid via an instrument port defining a flow path for instrument gas to pass into the interior volume of the cylinder to control operation of the fluid control device.

19. The method of claim 18, wherein the instrument is housed within a pressurized chamber included in the unitary assembly.

20. The method of claim 19, further comprising:
connecting the pressurized chamber to a downstream portion of a pipeline to reinject leaked instrument gas into the downstream portion of the pipeline.
